(19) United States
(12) Patent Application Publication
(10) Pub. No.: US 2024/0084951 A1
(43) Pub. Date: Mar. 14, 2024

(54) HEAT INSULATING MATERIAL

(71) Applicant: CHAFFLOSE Corporation, Kanagawa (JP)

(72) Inventors: Koji SASAYA, Saitama (JP); Atsushi FURUSAKI, Asahikawa (JP)

(21) Appl. No.: 18/461,769

(22) Filed: Sep. 6, 2023

(30) Foreign Application Priority Data
Sep. 8, 2022 (JP) 2022-143118

(51) Int. Cl. F16L 59/02; C09D 5/00; C09D 7/61; D06N 3/00

(52) U.S. Cl. CPC F16L 59/028; C09D 5/00; C09D 7/61; D06N 3/0006; D06N 3/0009; D06N 3/0061; D06N 3/0063; C08K 11/005; D06N 2205/10; D06N 2209/065; D06N 2209/067; D06N 2211/06

(57) ABSTRACT

Waste such as sawdust, waste paper, a shell of an oyster or the like, fallen leaves, old clothing fabric, and waste fishing nets as well as a wood construction waste material or a material from logging are effectively used, and burdens on the natural environment, which have been caused by the disposal of waste by incineration and the disposal by landfill, is reduced. A heat insulating material includes: a paint that contains, as components, a resin and powdered calcium composed of a fired ground product of scallop shells; and a core to be mixed with the paint.

### TECHNICAL FIELD

The present invention relates to a heat insulating material utilizing a paint composed of a naturally occurring scallop shell.

### BACKGROUND ART

After scallops are unloaded at ports, and edible portions are removed, large amounts of shells have been disposed of as waste, and various effective uses of waste scallop shells have been proposed.

A known example thereof is an idea for obtaining a fire-resistant wall coating material that contains: a scallop shell powder obtained from a ground product prepared through solar drying, firing, and grinding; and carboxymethyl cellulose as an adhesive agent obtained from a naturally occurring material (NPL 1). Furthermore, scallop shells exhibit porosity even in a powder form and have an action of adsorbing and decomposing formaldehyde that is released into air from construction materials, wall materials, and others (NPL 2).

Also, NPL 3 discloses an idea of mixing a ground product of non-fired scallop shells as an aggregate into a mortar for a purpose of utilizing a scallop shell powder as an aggregate in an interior plastering material in order to exert antifungal effects.

In addition, PTL 1 discloses wet blowing of an organic fiber-based heat insulating material in which a blowing material is blown into and thereby made to fill the internal spaces of building constituting members such as a wall, a ceiling, and a floor of a building such as a house. PTL 1 also discloses a mixture of cellulose fibers as natural wood fibers obtained by fibrillating waste paper, a natural adhesive agent, and shell calcium (a fired product of ground scallop shells, which is hydrated calcium hydroxide or calcium oxide obtained by oxidizing calcium carbonate, which is the main component of shells).

PTL1 further discloses that this blowing material and water fill a space partitioned by an external wall finishing material, a construction sheet, a column, and a stud, forming an organic fiber-based heat insulating material which serves as a heat insulating layer.

PTL1 further discloses that shell calcium contained in the blowing material has the function of adsorbing and decomposing hazardous substances and pollution substances in the air and a deodorizing function. These functions serve to suppress the occurrence of sick house syndrome which has an adverse effect on the health of a resident.

### CITATION LIST

### Non Patent Literature

NPL 1: Scallop Shell Paint, Interior Finishing Material (https://www.chaff-scallop.co.jp/chaffwall/chaffwallpanf.pdf)
NPL 2: Effective use of scallop shell “Bionic Design of the Scallop Shell, Nobuji KOYAMA” (https://ms-laboratory.jp/scallop/scallop.htm)
NPL 3: Thesis “Study on Construction Material Development and Construction Method Utilizing Scallop Shell” (September 2021, Graduate School of Hokkaido University of Science, Yukio Komatsu)

### PATENT LITERATURE

PTL 1: Japanese Patent No. 4308877

### SUMMARY OF INVENTION

### Technical Problem

Other than the above-described scallop shells, many undesired substances are also disposed of as waste. For example, sawdust, waste paper, a shell of an oyster or the like, fallen leaves, old clothing fabric, and waste fishing nets have been disposed of as waste. The disposal of such wastes has caused problems such as environmental contamination due to waste incineration and a lack of landfills.

Given these concerns, the problem is to effectively use waste such as sawdust, waste paper, a shell of an oyster or the like, fallen leaves, old clothing fabric, and waste fishing nets as well as wood construction waste materials or materials from logging, and an object is to reduce burdens on the natural environment that have been caused by disposal of waste by incineration and disposal by landfill.

### Solution to Problem

(Invention of Claim 1)

The present invention has been made in consideration of the above-mentioned problems, and provides a heat insulating material including:
a paint that contains, as components, a resin and powdered calcium composed of a fired ground product of scallop shells; and
a core to be mixed with the paint to support the paint, thereby solving the above-mentioned problem.

(Invention of Claim 2)

In the above-described invention, it is preferable that the paint contain
a non-fired ground product of scallop shells which is biomass that has, as the main component, calcium carbonate synthesized by utilizing carbon dioxide and calcium in the sea and that prevents the carbon dioxide from being released to the atmosphere.

(Invention of Claim 3)

In the above-described invention, it is also preferable that the paint contain
chaff which is biomass that has, as the main component, a carbohydrate generated through photosynthesis between water and carbon dioxide in the atmosphere and that prevents the carbon dioxide from being released to the atmosphere.

(Invention of Claim 4)

In the above-described invention, it is also preferable that a mixture obtained by mixing the paint and the core be porous.

(Invention of Claim 5)

In the above-described invention, it is also preferable that the mixture being porous be formed in an aggregate form of small lumps.

(Invention of Claim 6)

In the above-described invention, it is also preferable that the core be a wood material including a wood construction waste material or a material from logging.

(Invention of Claim 7)

In the above-described invention, it is also preferable that the core be a fiber material including woven fabric or knitted fabric and that the core exhibit a woven fabric form or a knitted fabric form.

(Invention of Claim 8)

In the above-described invention, it is also preferable that the core be an agglomerate in which a fiber material including woven fabric or knitted fabric is accumulated in a lump-like shape.

(Invention of Claim 9)

Another invention is a heat insulating material including:
a paint that contains, as components, a resin and powdered calcium composed of a fired ground product of scallop shells; and
a core to which the paint is fixed, wherein
the core is a plate-like wood material including a wood construction waste material or a material from logging, and the paint is fixed to the surface of the plate-like core, so that the heat insulating material is in a flat-plate shape. The present invention provides the heat insulating material, thereby solving the above-mentioned problem.

### Advantageous Effects of Invention

(Effect of Invention of Claim 1)

According to the invention of claim 1, the heat insulating material includes: a paint that contains, as the components, a resin and powdered calcium composed of a fired ground product of scallop shells; and a core to be mixed with this paint. Therefore, the heat insulating material includes the core on which surface the paint is placed, and waste and undesired substances can be used as the core.

(Effect of Invention of Claim 2)

According to the invention of claim 2, it is configured to use a non-fired ground product of scallop shells as biomass and also as an incombustible substance, and non-fired scallop shells which have been disposed of as waste can thus be effectively used.

Also, in the process of growing a shell, a scallop takes in carbon dioxide and calcium from the sea to form a shell with the carbon dioxide and calcium as the raw materials. Therefore, even when a non-fired scallop shell is made in the form of a ground product, carbon dioxide that was taken in as a shell-forming material in the growing process is not separated, and the use of a non-fired ground product of scallop shells is advantageous in that the release of a greenhouse effect gas into the atmosphere is suppressed.

The biomass represents reusable organic resources obtained from animal and plant (excluding fossil fuels such as petroleum).

(Effect of Invention of Claim 3)

According to the invention of claim 3, it is configured to use chaff as biomass, and chaff can be effectively used as a semi-incombustible substance without performing incineration, which has been conventionally adopted as a disposal measure.

Also, chaff is a part of a plant tissue formed by taking in carbon dioxide from the atmosphere and undergoing photosynthesis with water in forming a plant tissue. Even when chaff is made in the form of a ground product, carbon dioxide taken in from the atmosphere during rice growth is not separated, and the use of a ground product of chaff provides the advantage of suppressing the release of a greenhouse effect gas into the atmosphere.

(Effect of Invention of Claim 4)

According to the invention of claim 4, the mixture of the paint and the core is porous. Therefore, the heat insulating material itself has air permeability.

Furthermore, it is known that powdered calcium composed of a fired ground product of scallop shells in the paint has the function of adsorbing and decomposing hazardous substances such as formaldehyde in the air.

Therefore, hazardous substances in the air are adsorbed and decomposed when air passes through the porous parts of the heat insulating material, and air can be cleaned by the heat insulating material.

(Effect of Invention of Claim 5)

According to the invention of claim 5, the mixture of the paint and the core exhibits a form of an agglomerate of small lumps. When a plurality of small lumps is prepared and put in a bag, it is possible to dispose the heat insulating material according to the shape of the space, even in a small or in an oddly shaped place where, for example, a stud exists in a wall.

(Effect of Invention of Claim 6)

According to the invention of claim 6, the core is a wood material including a wood construction waste material or a material from logging. Therefore, a wood construction waste material generated by disassembling a folk dwelling or the like and a material from logging generated by forest management activities, can be effectively used as biomass.

(Effect of Invention of Claim 7)

According to the invention of claim 7, the core is a fiber material including woven fabric or knitted fabric and exhibits a woven fabric form or a knitted fabric form, and therefore a heat insulating material with good fixability of the paint to the core is achieved.

(Effect of Invention of Claim 8)

Examples of the fiber material including woven fabric or knitted fabric include old clothing fabric and waste fishing nets. According to the invention of claim 8, the above-described core is an agglomerate in which a fiber material including woven fabric or knitted fabric is accumulated in a lump-like shape. Therefore, the invention exhibits the effect whereby old clothing fabrics or waste fishing nets which have conventionally been disposed of as waste can be used as a part of the heat insulating material.

(Effect of Invention of Claim 9)

According to the invention of claim 9, the effect whereby the heat insulating material including a wood construction waste material or a material from logging can be adopted as a new construction material is exhibited.

### BRIEF DESCRIPTION OF DRAWINGS

FIG. 1 is an explanatory view schematically illustrating a cross section of a first embodiment of a heat insulating material of the present invention.

FIG. 2 is an explanatory view schematically illustrating a lump-like shape.

FIG. 3 is an explanatory view schematically illustrating a second embodiment of the same.

### DESCRIPTION OF EMBODIMENTS

### First Embodiment

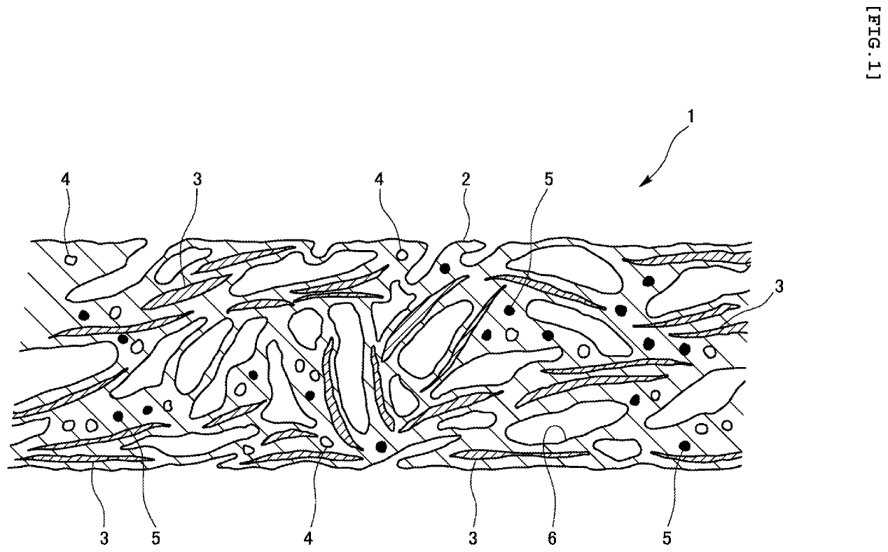

Next, the present invention will be described in detail on the basis of the drawings. FIG. 1 is a cross section of a first embodiment of the present invention. FIG. 1 illustrates a heat insulating material that is porous, and the heat insulating material 1 includes a paint 2 and a core 3.

(Paint)

The paint 2 of the heat insulating material 1 contains, as components, powdered calcium that is composed of a fired ground product of scallop shells, and a resin that is composed of, for example, carboxymethyl cellulose. A naturally occurring material is used as the material for preparation of the entirety of the paint. This paint 2 itself is an incombustible material. Regarding the production process to obtain powdered calcium from scallop shells, the firing temperature is adjusted such that carbon dioxide is not generated.

The paint 2 is also mixed with a non-fired ground product 4 of scallop shells, which is biomass and is also an incombustible substance, and a chaff 5, which is biomass as well and is also a dried semi-incombustible substance.

Regarding the paint 2, the blending amounts of the non-fired ground product 4 of scallop shells and the chaff 5 relative to the total amount of the paint 2 are adjusted, as are the grinding particle sizes of the non-fired ground product 4 of scallop shells and the chaff 5. This adjustment is done in order to not impair a state of the paint 2, while in a state of containing a required solvent, being fixed to an object to be coated or an object to be impregnated.

It has been described in the present embodiment that the paint 2 contains both the non-fired ground product 4 of scallop shells, which is biomass, and the dried chaff 5, which is also biomass, in the components as a mixture. However, the present invention is not limited to this example.

For example, the paint 2 may be one that contains any one of the non-fired ground product 4 of scallop shells and the chaff 5 in the component.

(Core)

The core 3 has been an undesired substance or waste as described later in the heat insulating material 1 of the present embodiment, and the use of an undesired substance or waste as the core 3 in the heat insulating material 1 makes the undesired substance and waste useful matters.

The core 3 in the above-described embodiment is porous and fixes and supports the paint 2 in the backbone part of the pores when mixed with the paint 2. The mixture obtained by mixing the paint 2 and the core 3 is also formed in a porous state with increased porous parts.

The part formed in a porous state includes multiple through holes 6 through which air can move, and powdered calcium of the paint 2 is present on the surfaces of the multiple through holes 6, allowing the adsorption and decomposition of hazardous substances in the air to efficiently proceed in this powdered calcium.

Also, since the mixture of the paint 2 and the core 3 is in a porous state in the heat insulating material 1 according to the first embodiment, the heat insulating material 1 itself is configured as a heat insulating member that has a certain thickness while being light in weight.

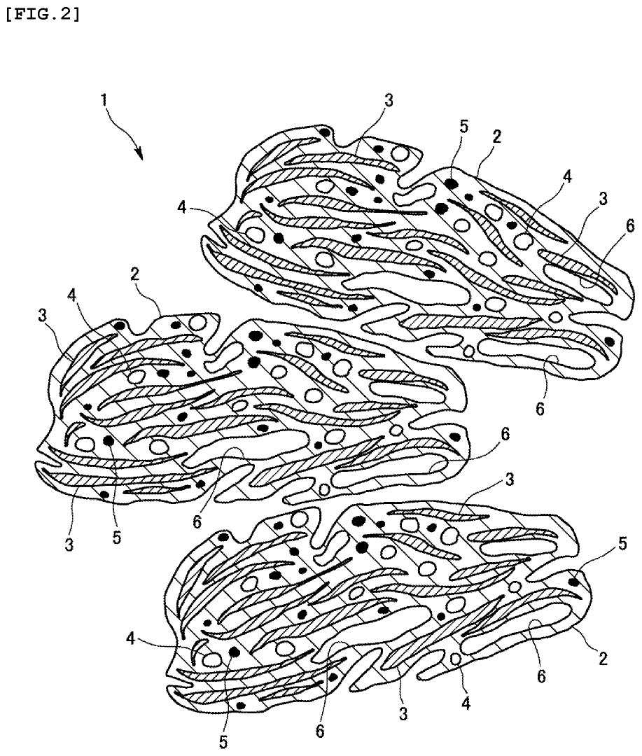

As the constituent material of the core 3, sawdust or waste paper, fallen leaves, and a shell of an oyster or the like can be adopted. Sawdust, waste paper, and fallen leaves that have conventionally been disposed of as waste are classified and each class of waste is accumulated to be formed into a plate-like form or a lump form. Thus, the porous core 3 can be obtained. Then, the porous core 3 is mixed with the paint 2 to obtain a mixture which is also porous with a plate-like shape (FIG. 1) or a lump-like shape (FIG. 2). Thus, the mixture can achieve a form with an enormously large number of holes without difficulty. The previously-described shell of an oyster or the like, after the edible portions are removed, is also disposed of as waste. The shell portion of an oyster or the like can also be used as a material constituting the core 3. The size or the like thereof may be adjusted by performing grinding or the like as necessary.

The core 3 may also be a fiber material including woven fabric or knitted fabric and be in a woven fabric form or a knitted fabric form. Specific examples thereof include old clothing fabric and waste fishing nets, and these can be adopted as the core 3. These fiber materials are accumulated in a lump-like shape to form an agglomerate of multiple lumps or a plate-like agglomerate, and the resulting core is mixed with the paint 2.

In the same manner as the above-described example, the mixture produced by mixing the core 3 with the paint 2 is also porous with a lump-like shape or a plate-like shape and can achieve a form including an enormously large number of holes without difficulty.

An example of the method for mixing the paint 2 and the core 3 is coating or impregnating the core 3 with the paint 2 and thereafter curing the paint 2 to obtain the heat insulating material 1.

When the heat insulating material 1 is formed as the mixture having a lump-like shape, a method including fabricating the heat insulating material 1 so as to exhibit the form of an agglomerate of small lumps, putting this agglomerate of small lumps in a bag, and attaching the bag inside a wall of a building can be adopted.

### Second Embodiment

In the heat insulating material 1 of the above-described embodiment, the paint 2 contains, in the paint components, the non-fired ground product 4 of scallop shells and the chaff 5, and the paint 2 and the core 3 are included to form a porous structure that supports the paint 2 on parts of the core 3 (a structure in a state of having multiple holes). However, the present invention is not limited to this embodiment and can also be according to a second embodiment illustrated below.

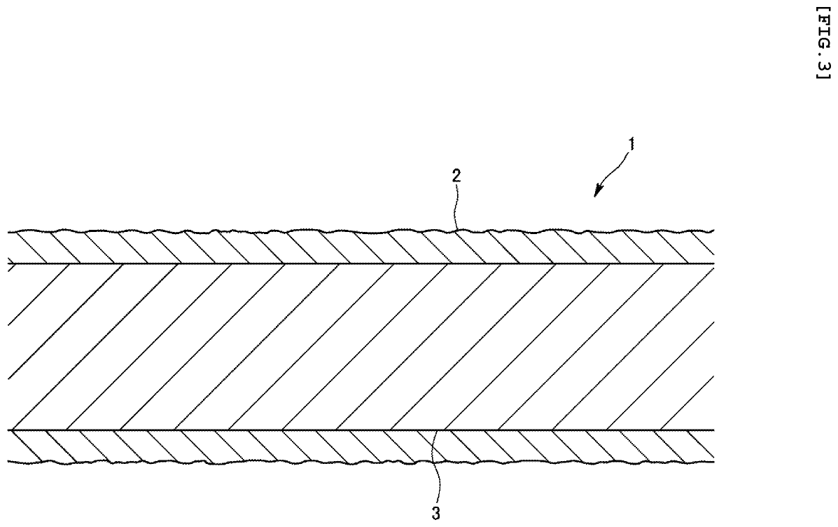

That is, according to the second embodiment, the core 3 of the heat insulating material 1 is composed of a wood construction waste material or a material from logging, as illustrated in FIG. 3.

This core 3 has a plate-like shape, and the paint 2 is applied on and fixed to the surfaces of the core 3 to form the heat insulating material 1 which also has a plate-like shape.

According to the second embodiment, the paint 2 contains, in the paint components, neither the non-fired ground product 4 of scallop shells as an incombustible substance nor the chaff 5 as a semi-incombustible substance. The paint component does not need to contain both the non-fired ground product 4 of scallop shells and the chaff 5. Any one of them may be contained, or neither may be contained. This technical matter is also applied to the paint 2 according to the first embodiment.

### REFERENCE SIGNS LIST

1 heat insulating material
2 paint
3 core
4 non-fired ground product of scallop shells
5 chaff
6 through hole

1. A heat insulating material comprising:
a paint that contains, as components, a resin and powdered calcium composed of a fired ground product of scallop shells; and
a core to be mixed with the paint to support the paint.

2. The heat insulating material according to claim 1, wherein the paint contains a non-fired ground product of scallop shells which is biomass that has, as a main component, calcium carbonate synthesized by utilizing carbon dioxide and calcium in the sea and that prevents the carbon dioxide from being released to atmosphere.

3. The heat insulating material according to claim 1, wherein the paint contains chaff which is biomass that has, as a main component, a carbohydrate generated through photosynthesis between water and carbon dioxide in the atmosphere and that prevents the carbon dioxide from being released to the atmosphere.

4. The heat insulating material according to claim 1, wherein a mixture obtained by mixing the paint and the core is porous.

5. The heat insulating material according to claim 4, wherein the mixture being porous is formed in an agglomerate form of small lumps.

6. The heat insulating material according to claim 1, wherein the core is a wood material including a wood construction waste material or a material from logging.

7. The heat insulating material according to claim 1, wherein the core is a fiber material including woven fabric or knitted fabric and exhibits a woven fabric form or a knitted fabric form.

8. The heat insulating material according to claim 1, wherein the core is an agglomerate in which a fiber material including woven fabric or knitted fabric is accumulated in a lump-like shape.

9. A heat insulating material comprising:
a paint that contains, as components, a resin and powdered calcium composed of a fired ground product of scallop shells; and
a core to which the paint is fixed, wherein:
the core is a plate-like wood material including a wood construction waste material or a material from logging; and
the paint is fixed to a surface of the plate-like core, so that the heat insulating material is in a flat-plate shape.
